(19) United States
(12) Patent Application Publication
(10) Pub. No.: US 2011/0144776 A1
(43) Pub. Date: Jun. 16, 2011

(54) SYSTEM AND METHOD FOR THE SIMPLIFIED OPERATION AND MANIPULATION OF AN AUTOMATION AND/OR PROCESS CONTROL SYSTEM

(75) Inventors: Martin Hollender, Dossenheim (DE); Kristoffer Husoy, Oslo (NO); Tone-Grete Graven, Nesoddtangen (NO)

(73) Assignee: ABB TECHNOLOGY AG, Zurich (CH)

(21) Appl. No.: 12/966,475

(22) Filed: Dec. 13, 2010

Related U.S. Application Data
(63) Continuation of application No. PCT/EP2009/004215, filed on Jun. 12, 2009.

(30) Foreign Application Priority Data
Jun. 11, 2008 (DE) 10 2008 027 834.3

(51) Int. Cl. G05B 13/02

(52) U.S. Cl. 700/49

(57) ABSTRACT

A system and method are provided for the simplified operation of an automation system. The system and method link knowledge-based and/or empirical and historical data to real-time data, such as alarm messages and/or event messages, in cooperation with a control system, such as a process control system. Data and/or links or references to data and/or process states are acquired and stored by means of a first data processing device and can be made available to at least one second data processing device for further processing via at least one allocated communication link, such as a network or bus system.

### RELATED APPLICATIONS

This application claims priority as a continuation application under 35 U.S.C. §120 to PCT/EP2009/004215, which was filed as an International Application on Jun. 12, 2009, designating the U.S., and which claims priority to German Application 10 2008 027 834.3 filed in Germany on Jun. 11, 2008. The entire contents of these applications are hereby incorporated by reference in their entireties.

### FIELD

The present disclosure relates to a system and a method for the simplified operation and manipulation of an automation and/or process control system through the incorporation of consistent and efficient information and knowledge management.

### BACKGROUND INFORMATION

Human decision-makers are confronted with numerous challenges when controlling complex dynamic installations and/or devices. Continuous organizational changes, adaptations or improvements as well as technological developments in increasingly more complex systems and the wealth of the available information which needs to be taken into account complicate the decision-making process and make it difficult to predict and/or estimate possible side effects and/or consequences or activities which in turn arise or result therefrom.

Despite the dynamics of the processes to be monitored and the demographic transition, known user interfaces and decision-making aids available in monitoring and control rooms or centers are relatively static and inflexible and have only a minimum number of adaptation possibilities. After a technical installation and/or device has/have been started up, the systems and components initially used are generally retained for many years without further change/adaptation, even when characteristics and operating modes of the respective process change and the know-how and expert knowledge of the operating personnel and/or operators relating to the different operating states and methods of operation as well as the behavior of the different technical devices in the respective installation have continually increased and built up in the ongoing operating period.

The practices of collecting, protecting and storing knowledge and know-how acquired in this respect, with regard to optimal or optimized methods and process sequences, for example, are considered to be a key factor for increasing competitiveness within a respective organization. Therefore, many different approaches have been pursued in the past in order to achieve this with the aid of appropriate tools.

Knowledge management initiatives for the cooperation of several individuals are generally considered to be particularly inefficient or unproductive. One reason may be that knowledge management initiatives are geared more toward a business perspective and thus an entirety rather than toward the individual employee. Another difficulty appears to lie in the fact that the knowledge management tools are not adequately or sufficiently integrated in or linked to those tools which are needed by the respective user to manage his tasks. These are essentially alarm and event lists, trend and process graphs in the case of an operator in a monitoring or control room.

For example, EEMUA 191, as an alarm system guideline, provides some crucial basic rules for designing and configuring alarm systems. These rules must be followed in order to design or conceive a viable or usable alarm system. EEMUA 191 is the industry standard for developing alarm systems. In accordance with this guideline, any alarm message should contain information relating to the respective problem and should provide assistance in terms of how the respective operator should behave with respect to the respective alarm.

The EEMUA guideline also instructs that only those warnings for which there is a defined response, such as a specific rule of conduct or instruction, for the operator should be generated. It is also recommended for appropriate rules of conduct to be available and to be made accessible to the operator for any alarm defined in the system.

The practices of establishing and embracing such suitable and usable rules of conduct for any known alarm in a system signify an enormous amount of effort, such as in relatively large and complex systems and installations, including those having a multiplicity of different alarms, and are also associated with considerable costs even if such work is already done at the start of development work.

In the case of older devices and installations, only the experienced operators have the necessary know-how and expert knowledge regarding which alarms are important in or for the respective operating state, what the possible causes are, what the respective effects and consequences are and what measures need to be taken.

Known systems currently do not provide any possibilities for efficiently integrating this expert and specialized knowledge in existing control and/or monitoring systems and using such knowledge according to the system.

Only the possibility of acquiring and/or managing such information manually or by hand using separated or separate independent systems, for example in the form of paper lists, tables or using notepads, are known to be used.

However, consistent and efficient information and knowledge management, as the basis for effective operation and/or manipulation of an automation system or installation, is not possible in this way or is possible only to a limited extent, and the risk of a malfunction on account of losses of knowledge and/or information, even in the sense of information not being found in good time, appears to be very high in this case, such as in the event of a fault.

Exemplary embodiments of the present disclosure provide a way of efficiently operating and/or manipulating an automation system.

### SUMMARY

An exemplary embodiment provides a system for the simplified operation and/or manipulation of an automation system. The exemplary system for the simplified operation and/or manipulation includes a control system and a data processing device. The control system has knowledge-based and/or empirical and historical information stored therein. The data processing device is configured to link the knowledge-based and/or empirical and historical information stored in the control system to real-time information in a database to enable a user to retrieve and/or call up the linked information, and access and acquire information and/or links or references to information and/or process states in a protected and accessible manner through the data processing device. The data processing device is also configured to provide the linked information to at least one additional data processing device for further use via at least one communication connection between the data processing device and the additional data processing device.

An exemplary embodiment provides a method for the simplified operation and/or manipulation of an automation system. The exemplary method includes storing knowledge-based and/or empirical and historical information in a control system. The exemplary method also includes linking, by a data processing device, the knowledge-based and/or empirical and historical information stored in the control system to real-time information in a database to enable a user to retreive and/or call up the linked information, and access and acquire information and/or links or references to information and/or process states in a protected and accessible manner. The exemplary method also includes providing the linked information to at least one additional data processing device for further use via at least one communication connection between the data processing device and the additional data processing device.

### BRIEF DESCRIPTION OF THE DRAWINGS

Additional refinements, advantages and features of the present disclosure are described in more detail below with reference to exemplary embodiments illustrated in the drawings, in which:

FIG. 1 shows links according to an exemplary system and method according to an embodiment of the present disclosure, between control system elements and information in electronic form, such as knowledge-based information;

FIG. 2 shows exemplary alarm handling associations according to an embodiment of the present disclosure;

FIG. 3 shows an example of an implementation of a search facility according to an embodiment of the present disclosure;

FIG. 4 shows exemplary information and links which are associated with an alarm event or an alarm; and

FIG. 5 shows an example of an implementation of a reference call and bookmark detection according to an embodiment of the present disclosure.

### DETAILED DESCRIPTION

Exemplary embodiments of the present disclosure provide a system and method for the simplified operation and/or manipulation of an automation system.

Exemplary embodiments of the present disclosure provide a system and method for the simplified operation and/or manipulation of an automation system which, in cooperation with a control system (e.g., a process control system) link knowledge-based and/or empirical and historical information to real-time information, such as alarm messages and/or event messages, for example, in such a manner that the information can be retrieved or called up, information and/or links or references to information and/or process states are able to be acquired and protected (e.g., stored) in an accessible manner using a first data processing device and are able to be provided to at least one second data processing device for further use via at least one communication connection provided for this purpose, such as a network or bus system, for example.

In accordance with an exemplary embodiment, the respective information can already be assessed and/or classified in a preparatory manner depending on the operating and/or process state or the environment. Moreover, the respective information can be assessed and/or classified using an assessment tool provided and supplied according to the system, for example, with regard to whether the respective information is relevant in the respective state. In addition, the assessments and classifications available in this respect can also be changed and/or adapted according to the system and method, as a result of which newly collected and/or changing and/or application-specific empirical values can also be included in the respective assessments in a timely manner.

In accordance with an exemplary embodiment, graphs and/or trend plots, development curves and/or illustrations can be called up and/or generated in an automated manner using a link and/or reference, and/or predetermined functions and/or procedures of the control system and/or manuals, e.g., operating manuals, and/or faceplates and/or views can be called up and/or any other information available in electronic form can be called up from the control system, e.g., from alarm and/or event lists and/or help documents and/or help calls of the control system.

In this case, provision may be made for the respective call to be made immediately and/or directly from the control system and/or the respective control system element.

In accordance with an exemplary embodiment, the information which has been assessed and/or classified as relevant to the respective operating or process state or has been associated with the respective state and/or the respective environment, such as the process environment, for example, can be provided or the selection is restricted to such information.

In accordance with an exemplary embodiment, the links or associations between the operating state or operating environment and respective information are effected using predeterminable keywords and/or code words, so-called “metadata”.

One example of such metadata could be:

Process state=STARTING or NORMAL OPERATION or FULL LOAD or SHUTDOWN.

A process state detector which automatically correctly determines and/or sets the process state variable can be provided for this purpose.

Another metadatum or example of metadata would be the name of the author. It is automatically set, with the result that it is subsequently possible to search for all contributions by “mholl”, for example, using an appropriate search tool. Details relating to the date, location, area of use, utilization, servicing and maintenance, operating hours and the like as well as general state and/or process and/or equipment information, for example also manufacturers, or a combination thereof may also be part of the metadata.

However, the examples explained here in no way limit the subject matter of the disclosure and the multifarious different types of metadata which can be used but rather show only an exemplary selection.

It is advantageous in this case that the plant operator or operator does not need to worry about these tags himself.

In accordance with an exemplary embodiment of the system, the respective information is linked to or associated with a respectively predetermined emergency, e.g., an alarm state, for example a “high” alarm from a level detector or indicator, using tagging and/or is linked to or associated with a respectively predetermined alarm state using a code word. The code word can describe, for example, equipment and/or an installation or process component and/or a set of characteristic variables and/or parameters and/or individual states which describe and/or define a particular system, installation or process state.

In an abnormal situation or exceptional situation, such as in the event of a fault or an incident, a display, which displays all information and navigation connections and/or links which have previously been assessed or marked as relevant to this particular situation or this operating or process state or environment, can be called up as required, e.g., by the respective operator, or on request or else automatically.

In accordance with an exemplary embodiment, this display can be called up, for example, by selecting or choosing a warning or an alarm in the warning or alarm list or an event in an event list. If alarm or event handling information or behavioral measures with respect to the respective alarm or event is/are available or can be retrieved from a corresponding database, this information can be directly displayed and viewed on this display. Even if connections and/or links to the faceplates or trend plots have been stored at an earlier point in time, connections/links to this information are displayed on the same display.

In accordance with an exemplary embodiment, the information connections and/or links can be grouped using code words, where the code words describe their content or subject matter and/or function.

According to an exemplary embodiment, the respective operator can store links and/or references and/or paths to open windows or views and associate them with an abnormal situation and/or an alarm and/or a state if he has the appropriate information, in a similar manner to storing a bookmark for a web page, and to tag the association with a code word as a new reference.

In accordance with an exemplary embodiment, the same display/set of information can also be tagged or connected using a plurality of code words, such as a multiplicity of code words, where different code words can also be able to be grouped in a similar manner to the operation of the “social bookmark sharing tool” for web pages, for example.

In accordance with an exemplary, the operator can define code words which have been or are associated with alarms and/or events with similar properties and/or code words which identify and/or indicate alarms and/or events having similar properties. For example, a high-temperature alarm for a heat exchanger can be associated with all warnings/alarms for the heat exchanger inlet or outlet temperature.

Appropriate input means (e.g., a computer processing device) for detecting any inputs made according to the system and method in character and/or text form are advantageously provided.

This makes it possible to share and/or jointly use, in particular, known approaches and behavioral measures, know-how and knowledge as well as knowledge-based best-practice information even between different installations, between changing offshore personnel and the personnel in an integrated operating control center or process control center and/or monitoring station.

Exemplary embodiments of the present disclosure also provide a method for the simplified operation and/or manipulation of an automation system, including for execution in one of the corresponding systems mentioned above.

The method according to the disclosure is used, in cooperation with a control system, such as a process control system, for example, to link knowledge-based and/or empirical and historical information to real-time information (e.g., alarm and/or event messages) in such a manner that the information can be retrieved or called up, information and/or links or references to information and/or process states can be acquired and protected (e.g., stored) in an accessible manner using a first data processing device and being provided to at least one second data processing device for further use via at least one communication connection provided for this purpose, such as a network or bus system, for example.

In accordance with an exemplary embodiment, the respective information can be assessed and/or classified in a preparatory manner depending on the operating and/or process state or depending on the environment, for example, with regard to whether the respective information is relevant in the respective state. In addition, the relevant assessments and classifications can also be changed and/or adapted according to the method.

In accordance with an exemplary embodiment, graphs and/or trend plots or development curves or illustrations can be called up and/or generated in an automated manner and/or predetermined functions and/or procedures of the control system and/or manuals, e.g., operating manuals, and/or faceplates and/or views can be called up and/or any other information available in electronic form can be called up using links and/or references.

In accordance with an exemplary embodiment, the call can be executed and/or carried out directly from the control system and/or at least one control system element, e.g., from alarm and/or event lists and/or help documents and/or help calls of the control system.

In accordance with an exemplary embodiment of the method, the information which has been assessed and/or classified as relevant to the respective operating or process state or has been associated with the respective state or the respective environment is provided or the selection is restricted to such information.

In accordance with an exemplary embodiment, the links or associations between the operating state or operating environment and respective information are effected using predeterminable keywords and/or code words, so-called “metadata”, as already explained above.

In one development, the respective information is linked to or associated with a respectively predetermined alarm state, for example a “high” alarm from a level detector or indicator, using tagging and/or is linked to or associated with a respectively predetermined alarm state using a code word, where the code word describes equipment and/or an installation or process component and/or a set of characteristic variables and/or parameters and/or individual states which describe and/or define a particular system, installation or process state.

In an abnormal situation or else an exceptional situation, e.g., in the event of a fault or an incident, a display, which displays all information and navigation connections and/or links which have previously been assessed or marked as relevant to this particular situation or this operating or process state or environment, can be called up as required, e.g., by the respective operator, or on request or else automatically.

In accordance with an exemplary embodiment, the display can be called up, for example, by selecting or choosing a warning or an alarm in the warning or alarm list. If alarm handling information or behavioral measures with respect to the respective alarm is/are available or can be retrieved from a corresponding database, this information can be directly displayed and viewed on this display. Even if connections and/or links to the faceplates and/or trend plots have been stored at an earlier point in time, connections/links to this information are displayed on the same display.

In accordance with an exemplary embodiment, the information connections and/or links can be grouped using code words, where the code words describe their content or subject matter and/or function.

In accordance with an exemplary embodiment, the respective operator can store links and/or references and/or paths to open windows or views and associate them with an abnormal situation and/or an alarm and/or a state if he has the appropriate information, in a similar manner to storing a bookmark for a web page, and to tag the association with a code word as a new reference.

In an advantageous refinement, the same display/set of information can also be tagged or connected using a plurality of code words, such as a multiplicity of code words, where different code words can also be able to be grouped in a similar manner to the operation of the “social bookmark sharing tool” for web pages, for example.

In accordance with an exemplary embodiment, the operator can define code words which have been or are associated with alarms having similar properties and/or which define or indicate and/or identify alarms having similar properties. For example, a high-temperature alarm for a heat exchanger can be associated with all warnings/alarms for the heat exchanger inlet or outlet temperature.

This makes it possible to share and/or jointly use, e.g., known approaches and behavioral measures, know-how and knowledge as well as knowledge-based best-practice information even between different installations, between changing offshore personnel and the personnel in an integrated operating control center or process control center and/or monitoring station.

If a particular selection of trend plots or development illustrations is relevant to the respective warning/alarm message, it is also possible to deposit and/or store a corresponding connection and/or link to these plots and/or to associate or connect the connection and/or link with/to the object name and the state of the respective alarm or the respective warning message. The same plots or views and relevant information are available again and/or can be called up as a link from the alarm display or the alarm list and/or event list and/or help function or document whenever this warning/alarm occurs again.

In accordance with an exemplary embodiment, the included information can supplemented and/or superseded or updated with real-time information by calling up the respective link and/or connection in cooperation with the respective control system. This can advantageously be carried out automatically or as required using an instruction or call, e.g., by the operator and/or plant operator and/or user.

Provision may advantageously be made for comments and/or information to be recorded manually or by hand and to be marked or tagged using a code word, such that they can be found in a simpler manner at a subsequent point in time, e.g., by using a corresponding search or research tool. An association with a particular state, for example an alarm at a particular point in time, can also be advantageously provided using a code word or keyword.

In accordance with an exemplary embodiment, information can be called up directly from the respective alarm list and/or event list and/or any desired help or any desired help document and/or can be searched and/or researched using code words. Metadata can be used in this case in order to make it easier to access and/or retrieve the information in the system.

In this case, the respective taxonomy (systematics) can be defined by the respective user. For example, the operator can define a navigation connection and can connect it to all possible code words which he considers to be usable or useful.

However, specific paths and information flows can be stipulated and defined; if, for example, a trend or development plot is tagged, the system automatically inserts or adds one or more predetermined code words such as “trend” and/or presents the “tagname” (keyword/tag name) of the respective process parameter in the trend plot.

Exemplary embodiments of the present disclosure provide a simple and integrated possible way of adding knowledge-based information to a warning or an alarm and of being able to efficiently access and use this information in an abnormal situation, such as in the case of a fault, for example.

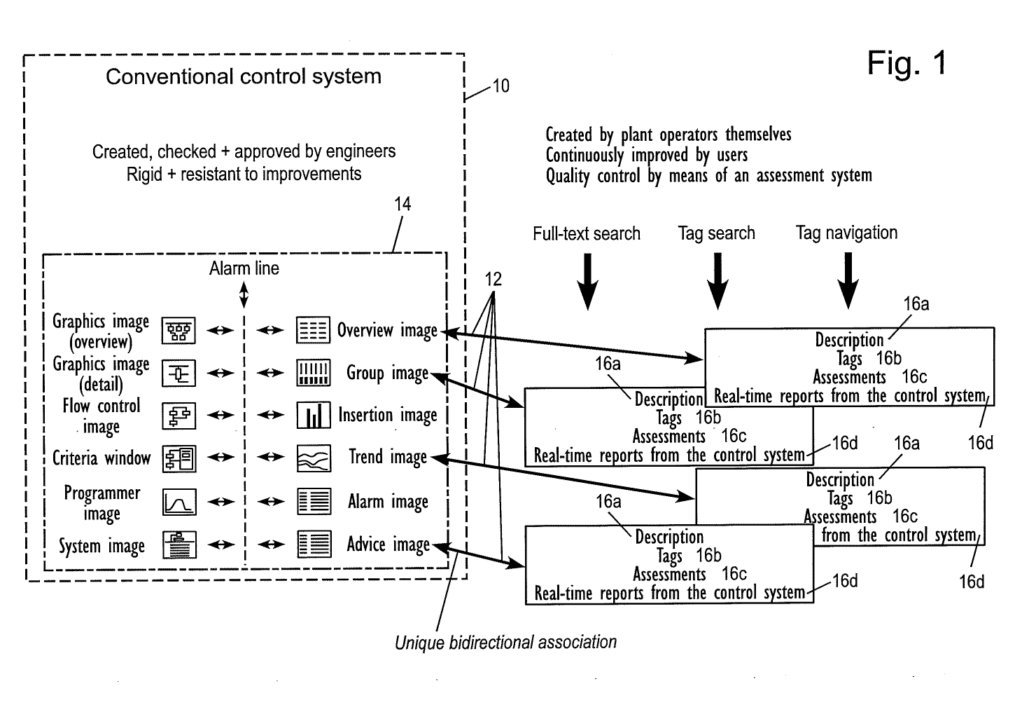

FIG. 1 indicates links 12 according to an exemplary system and method which are implemented, by way of example, between control system elements 14 and information in electronic form, e.g., knowledge-based information, in a system for the simplified operation and/or manipulation of an automation system. The respective links are indicated between individual control system elements 14 and further or additional available information 16a,b,c,d in electronic form, such as knowledge-based information, for example.

In this case, the electronic information may include, for example, descriptions 16a, manuals, tags 16b, assessments 16c and/or real-time reports 16d from the respective control system 10.

The exemplary system and method of the present disclosure make it possible, in cooperation with a control system 10, e.g., a process control system, to link knowledge-based and/or empirical and historical information 16a,b,c to real-time information 16d, such as alarm messages and/or event messages, for example. The information can be linked in such a manner that it can be retrieved or called up, such that information 16a,b,c,d and/or links or references 18 to information and/or process states can be acquired and protected, and can stored in at least one non-tangible data memory (e.g., a non-transitory computer-readable recording medium) and/or in at least one database, in an accessible manner using a first data processing device and being provided to at least one second data processing device for further use via at least one communication connection provided for this purpose, such as a network or bus system, for example.

As used herein, the term “tool” is used to describe a programmed electronic component configured to carry out the functions in which it is described to perform. According to an exemplary embodiment, the various tools described herein can be individually or collectively implemented, for example, by a computer processing device executing a specific computer program recorded on a non-transitory computer-readable program, such as a hard disk drive, ROM, a flash memory, optical memory, or any other non-volatile memory. A computer processing device executing a computer program recorded on a computer-readable recording medium is an example of a “data processing device” as used herein.

According to an exemplary embodiment, at least one assessment tool can be provided, with which the respective information can be assessed and/or classified depending on the operating and/or process state or depending on the environment, for example, with regard to whether the respective information is relevant in or to the respective state. In addition, the relevant assessments and classifications can also be changed and/or adapted according to the system and method.

As shown in FIG. 2, a development tool can also be provided. The development tool can be used to learn and/or develop alarm handling associations. In this case, it is possible to respectively predetermine time windows inside which the different actions or else lines of action are intended to be effected or carried out.

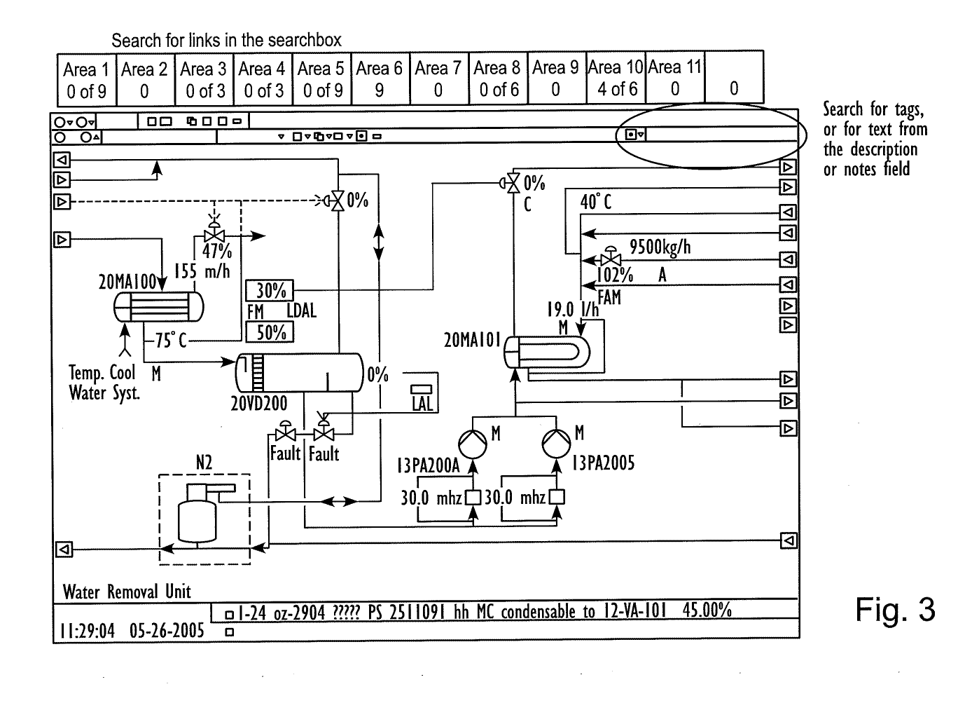

As can also be gathered from FIG. 3, at least one search or else research tool can also provided according to an exemplary embodiment of the system and/or method. The search or research tool enables a user to conduct a full-text search, for example for keywords, search terms, catchwords, designations or a combination thereof, and/or a tag or label search and/or tag navigation in the available information and/or databases and/or data memories and/or the Internet. The user can also conduct the search and/or research with the search or research tool starting from the respective control system elements, such as process diagrams and/or plans.

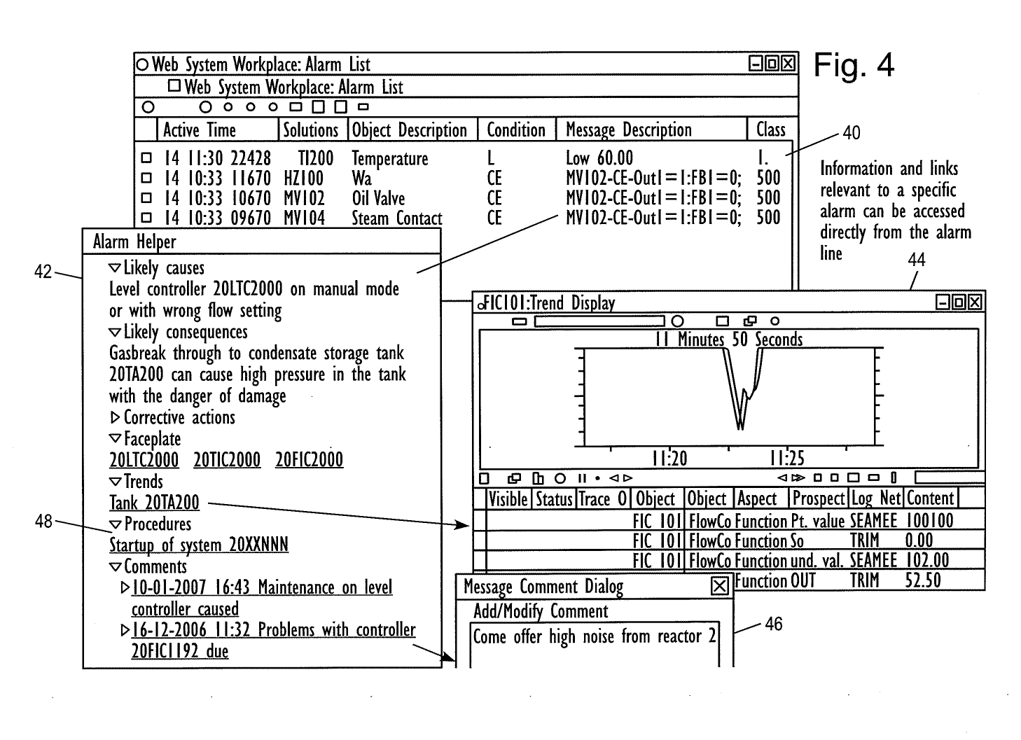

As can be gathered from FIG. 1 but also from FIG. 4, additional information 42, such as graphs and/or trend plots 44 or development curves or illustrations and/or messages and/or comments 46, can be called up and/or generated in an automated manner and/or predetermined functions and/or procedures 48 of the control system and/or manuals, e.g., operating manuals, and/or faceplates and/or views and/or any other information available in electronic form can be called up or retrieved, for example directly from an alarm list 40 and/or an event list and/or a help call, using links and/or references.

According to an exemplary embodiment, the information which has been assessed and/or classified as relevant to the respective operating or process state or has been associated with the respective state and/or the respective environment is provided or the selection is restricted to that information, for example.

The links and/or associations between the operating state and/or operating environment and respective information, for example, can also be effected using predeterminable keywords and/or code words, so-called “metadata”.

Means (e.g., a computer processing device) are also provided according to the system, with which means the respective information has or can be linked to or associated with a respectively predetermined alarm state, for example a “high” alarm from a level detector or indicator, using tagging, in particular using unique bidirectional associations, and/or is or has been linked to or associated with a respectively predetermined alarm state using a code word. In this case, the code word can describe equipment and/or an installation or process component and/or indicate or specify a set of characteristic variables and/or parameters and/or individual states which describe and/or define a particular system, installation or process state.

In an abnormal or else unusual situation or an exceptional situation, such as in the event of a fault or an incident, a display, which displays all information and navigation connections and/or links which have previously been assessed or marked as relevant to this particular situation or this operating or process state or environment, can be called up as required, for example by the respective operator, or on request or else automatically, as shown in FIG. 4.

This display can be called up, for example, by selecting or choosing a warning or an alarm or an event in the warning or alarm list or event list. If alarm handling information or behavioral measures with respect to the respective alarm is/are available or can be retrieved from a corresponding database, this information can be directly displayed and viewed on this display. Even if connections and/or links to the faceplates or trend plots, for example, have been stored at an earlier point in time, connections/links to this information are displayed on the same display.

In accordance with an exemplary embodiment, the information connections and/or links can be grouped using code words, where the code words describe their content or subject matter and/or their function.

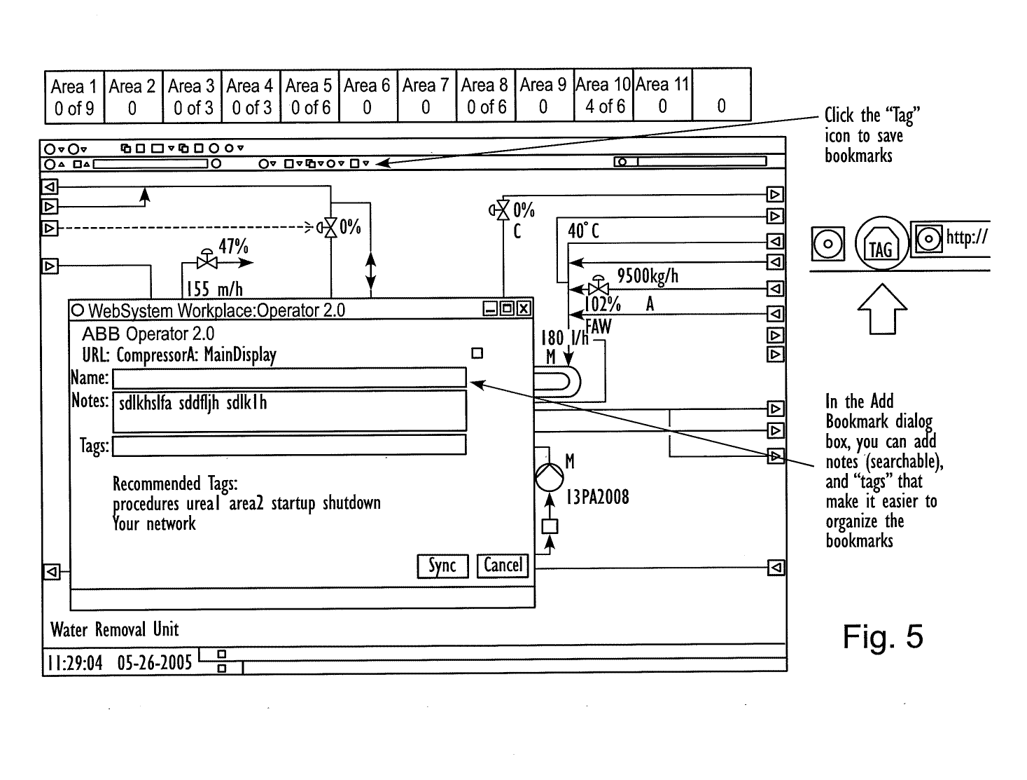

As indicated in FIG. 5, the respective operator or plant operator can likewise use a bookmark tool to record and/or deposit, in particular store, links and/or references and/or paths to open windows or views and to associate them with an abnormal and/or unusual situation and/or an alarm and/or an event and/or a state if he has the appropriate information, in a similar manner to storing a bookmark for a web page, and to tag or label the association with a code word as a new reference.

The same display or set of information can also be tagged or connected using a plurality of code words, such as a multiplicity of code words. Different code words can also be able to be grouped in a similar manner to the operation of the “social bookmark sharing tool” for web pages, for example. The different tags and/or code words or else information and/or comments can be freely researched or searched or looked through in this case.

According to an exemplary embodiment, code words which have been or are associated with alarms can be defined with similar properties. This makes it possible, for example, for a high-temperature alarm for a heat exchanger to be associated with all warnings/alarms for the heat exchanger inlet or outlet temperature.

According to exemplary embodiments of the present disclosure, it is possible to share and/or jointly use, for example, known approaches and behavioral measures, know-how and knowledge as well as knowledge-based best-practice information even between different installations, between changing offshore personnel and the personnel in an integrated operating control center or process control center and/or monitoring station.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A system for the simplified operation and/or manipulation of an automation system, comprising:
a control system having knowledge-based and/or empirical and historical information stored therein; and
a data processing device configured to link the knowledge-based and/or empirical and historical information stored in the control system to real-time information in a database to enable a user to retrieve and/or call up the linked information, and access and acquire information and/or links or references to information and/or process states in a protected and accessible manner through the data processing device, and configured to provide the linked information to at least one additional data processing device for further use via at least one communication connection between the data processing device and the additional data processing device.

2. The system as claimed in claim 1, comprising:
at least one assessment tool configured to at least one of assess and classify the respective information depending on at least one of an operating state, a process state, and and the environment.

3. The system as claimed in claim 2, wherein the assessment tool is configured to enable acquired assessments and classifications to be changed and/or adapted.

4. The system as claimed in claim 1, comprising:
at least one development tool configured to enable at least one of learning, development and training of alarm handling associations.

5. The system as claimed in claim 1, comprising:
wherein at least one search or research tool is provided, with which a full-text search, in particular for keywords, search terms, catchwords or designations, and/or a tag or label search and/or tag navigation in the available information and/or databases and/or the Internet can be effected and/or carried out, in particular also starting from the control system and/or the respective control system elements.

6. The system as claimed in claim 1, comprising:
means for at least one of calling up and generating in an automated manner additional information via links and/or references, the additional information including at least one of graphs, trend plots, development curves, illustrations, messages, comments, predetermined functions, procedures of the control system, procedures of operating manuals, faceplates, views, and information available in electronic form.

7. The system as claimed in claim 1, wherein links and/or associations between the operating state and/or operating environment and respective information are effected via at least one of predeterminable keywords, code words, and metadata.

8. The system as claimed in claim 1, wherein the data processing device is configured to at least one of link and associate the respective information with a respectively predetermined alarm state and/or an event using at least one of tagging and at least one code word.

9. The system as claimed in claim 1, comprising:
a display device configured to display all information and navigation connections and/or links which have previously been assessed or marked as relevant to the respective situation, operating or process state and/or environment,
wherein the display device is configured to call up the display as required or on request or automatically in the event of an abnormal or else unusual situation.

10. The system as claimed in claim 9, wherein the display device is configured to call up the display by selecting or choosing a warning or an alarm or an event in the warning or alarm list or the event list.

11. A method for the simplified operation and/or manipulation of an automation system, comprising:
storing knowledge-based and/or empirical and historical information in a control system;
linking, by a data processing device, the knowledge-based and/or empirical and historical information stored in the control system to real-time information in a database to enable a user to retreive and/or call up the linked information, and access and acquire information and/or links or references to information and/or process states in a protected and accessible manner;
providing the linked information to at least one additional data processing device for further use via at least one communication connection between the data processing device and the additional data processing device.

12. The method as claimed in claim 11, wherein the respective information is assessable and/or classifiable depending on at least one of an operating, a process state, and the environment, and whether the respective information is relevant in or to the respective state.

13. The method as claimed in claim 11, comprising:
calling up and/or generating in an automated manner additional information, via links and/or references, the additional information including at least one of graphs, trend plots, development curves, illustrations, predetermined functions, procedures of the control system, operating manuals of the control system, faceplates, views, and information available in electronic form.

14. The method as claimed in claim 11, comprising:
linking and/or associating the respective information with a respectively predetermined alarm state using at least one of tagging and at least one code word,
wherein the code word describes equipment and/or an installation or process component and is linked and/or connected to a set of characteristic variables and/or parameters and/or individual states which describe and/or define a particular system, installation or process state.

15. The system as claimed in claim 1, wherein the real-time information relates to at least one of an alarm message and an event message, and
wherein the communication connection comprises at least one of a network and bus system.

16. The system as claimed in claim 3, comprising:
at least one development tool configured to enable at least one of learning, development and training of alarm handling associations.

17. The system as claimed in claim 16, comprising:
at least one development tool configured to enable at least one of learning, development and training of alarm handling associations.

18. The system as claimed in claim 17, comprising:
means for at least one of calling up and generating in an automated manner additional information via links and/or references, the additional information including at least one of graphs, trend plots, development curves, illustrations, messages, comments, predetermined functions, procedures of the control system, procedures of operating manuals, faceplates, views, and information available in electronic form.

19. The system as claimed in claim 9, wherein the display device is configured to call up the display in the event of a fault or an incident.

20. The method as claimed in claim 12, comprising:
calling up and/or generating in an automated manner additional information, via links and/or references, the additional information including at least one of graphs, trend plots, development curves, illustrations, predetermined functions, procedures of the control system, operating manuals of the control system, faceplates, views, and information available in electronic form.

21. The method as claimed in claim 20, comprising:
linking and/or associating the respective information with a respectively predetermined alarm state using at least one of tagging and at least one code word,
wherein the code word describes equipment and/or an installation or process component and is linked and/or connected to a set of characteristic variables and/or parameters and/or individual states which describe and/or define a particular system, installation or process state.
